(19) United States
(12) Patent Application Publication
(10) Pub. No.: US 2012/0171916 A1
(43) Pub. Date: Jul. 5, 2012

(54) HIGH TENSILE STRENGTH ADHESIVE TAPE

(75) Inventors: Jerry Serra, Chelmsford, MA (US); Tina Killgore Wagnon, Hendersonville, TN (US)

(73) Assignee: BERRY PLASTICS CORPORATION, Evansville, IN (US)

(21) Appl. No.: 13/418,170

(22) Filed: Mar. 12, 2012

Related U.S. Application Data
(63) Continuation of application No. 12/013,424, filed on Jan. 12, 2008, now abandoned.
(60) Provisional application No. 60/884,802, filed on Jan. 12, 2007.

(51) Int. Cl. B32B 27/12; B32B 7/12

(52) U.S. Cl. 442/151; 428/352

(57) ABSTRACT

Embodiments of the present invention generally relate to adhesive tapes having high tensile strength properties. In particular, embodiments of the present invention relate to adhesive tapes having tensile strength greater than 50 pounds/inch, while maintaining hand tearability characteristics. In one embodiment, a high tensile strength adhesive tape comprises a backing layer, and an adhesive layer affixed to a surface of the backing layer, wherein the adhesive tape has a tensile strength of at least about 50 pounds per inch, and a tear strength of less than about 10 pounds.

### PRIORITY CLAIM

This is a continuation of U.S. application Ser. No. 12/013,424, filed Jan. 12, 2008, which claims the benefit of US Provisional Application No. 60/884,802, filed Jan. 12, 2007, both of which are incorporated herein by reference in their entirety.

### BACKGROUND OF THE INVENTION

1. Field of the Invention

Embodiments of the present invention generally relate to adhesive tapes having high tensile strength properties. In particular, embodiments of the present invention relate to adhesive tapes having tensile strength greater than 50 pounds/inch, while maintaining hand tearability characteristics.

2. Description of the Related Art

Adhesive tapes, specifically duct tapes and film/woven cloth tapes, are designed for applications based on their material properties. Many of the material properties are determined by the combination of adhesive type and the strength of the backing material. For example, standard adhesive tapes typically have tensile strengths in the range of 20-35 pounds/inch. Such tapes are beneficial for most household uses, and are desirable for their easy-to-tear characteristics, i.e., low tear strength. However, these tapes may fail when a significant tensile force is applied.

Tapes designed for “high strength” applications generally have a tensile strength in a range of 35-45 pounds/inch. While useful for many industrial applications, these tapes generally have high tear strength characteristics, thus requiring a tool, such as a knife, to tear. Also, these tapes may fail when subjected to very high tensile forces, i.e., greater than 50 pounds/inch.

Therefore, there is a need for a high tensile strength tape capable of withstanding high tensile forces greater than 50 pounds/inch, while maintaining hand tearability characteristics.

### SUMMARY OF THE INVENTION

Embodiments of the present invention generally relate to a high tensile strength tape having hand tearability characteristics. In one embodiment, A high tensile strength adhesive tape comprises a backing layer, and an adhesive layer affixed to a surface of the backing layer, wherein the adhesive tape has a tensile strength of at least about 50 pounds per inch, and a tear strength of less than about 10 pounds.

In another embodiment of the present invention, a high tensile strength adhesive tape comprises a backing layer comprising a woven cloth scrim, and a pressure-sensitive adhesive layer disposed on a surface of the backing, wherein the adhesive tape has a tensile strength of between about 50 pounds per inch and about 100 pounds per inch, and a tear strength of between about 0.05 pounds and about 10 pounds.

In yet another embodiment, a high tensile strength adhesive tape comprises a woven cloth scrim comprising a plurality of interlaced threads arranged in a grid density of about 28×44 threads per square inch, and a rubber-based pressure-sensitive adhesive layer disposed on a surface of the scrim, wherein the adhesive tape has a tensile strength of at least 50 pounds per inch and a tear strength of less than about 10 pounds.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts an adhesive tape in accordance with one embodiment of the present invention; and

FIG. 2 depicts a flowchart for a method of producing adhesive tape in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

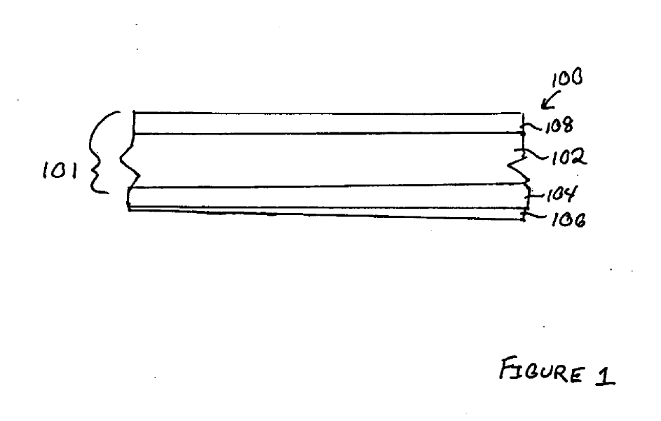

FIG. 1 depicts an adhesive tape in accordance with an embodiment of the present invention. The adhesive tape 100 may be a duct tape, electrical tape, cloth tape, masking tape, packing tape, stationary tape, or the like. In one embodiment, the adhesive tape 100 is a duct tape.

The adhesive tape 100 generally comprises a backing layer 101 and an adhesive layer 104. The adhesive tape 100 may optionally comprise a release liner material 106 applied to the layer of adhesive 104. The release liner 106 prevents the adhesive layer 104 from unnecessarily adhering to unintended objects, and allows for easy unwinding if packaged in roll form. However, omitting the release liner 106 facilitates the tape 100 to be manufactured and packaged as a self-wound roll.

In some embodiments of the present invention which do not comprise a release liner, the unwind force of the adhesive tape on the roll is between about 50 ounce-force/inch (about 5.5 N/cm) and about 200 ounce-force/inch (about 22 N/cm) when the adhesive tape is exposed to a temperature of 180° F. and is being unwound at a rate of about 12 in/min (30.5 cm/min). Additionally, in some embodiments of the present invention, the unwind force of the tape on the roll is between about 5 ounce-force/inch (about 0.55 N/cm) and about 75 ounce-force/inch (about 8.20 N/cm) when subjected to an unwind rate of about 100 ft/min (about 30.5 m/min).

In one embodiment of the present invention, the adhesion of the adhesive 104 to the backing layer 101 is between about 50 ounce-force/inch (about 5.5 N/cm) and about 150 ounce-force/inch (about 16.5 N/cm). In another embodiment of the present invention, the adhesion of the adhesive 104 to the backing layer 101 is between about 75 ounce-force/inch (about 8 N/cm) and about 125 ounce-force/inch (about 14 N/cm).

The backing layer 101 generally comprises at least a scrim 102, and optionally a film layer 108. The scrim 102 comprises a woven or non-woven material. The material may be any natural or synthetic textile material. In one embodiment, the scrim 102 is a cloth material such as cotton, and the like. Alternatively, the scrim 102 may comprise a woven or non-woven scrim material, including, but not limited to, cotton, polyester, nylon, one or more polymeric materials, and the like.

In one embodiment of the present invention, the scrim 102 is a woven cloth material. The woven cloth material is comprised of a plurality of interlaced threads. The interlaced threads may be formed such that when a tensile force is positively applied in either a machine direction or cross direction, or both, the threads reinforce one another, thereby resisting failure. The interlaced threads may be arranged in any conceivable fashion, including, but not limited to, grid patterns, aligned in parallel, randomly distributed, traditional woven patterns, and the like.

In one embodiment, the threads are arranged in a grid having a grid density in a range of about 5×10 threads per square inch to about 50×100 threads per square inch. In one embodiment, the threads are arranged in a grid having a grid density of about 28×44 threads per square inch.

The film layer 108 is disposed on one side of the scrim 102, or optionally encompassing the entire scrim 102. The film layer 108 is generally a polyethylene film. However, any polymer film is contemplated. Optionally, the film layer 108 may be multilayered. In one embodiment, the film layer 108 includes a tying layer (not shown) against the scrim 102. The tying layer may include ethylene methacrylate, ethylene vinyl acetate, or the like. The film layer 108 protects the backing layer 102 from moisture and abrasion, and effectively seals the backing layer 102. The film layer 108 provides enhanced surface area to which the adhesive layer 104 may adhere.

Some embodiments of the present invention provide abrasion resistant materials and/or toughness modifiers to the backing layer 102. Such materials include, but are not limited to, styrene block copolymers, polypropylene, K-resins, and the like. Other known protective materials may be added as well.

The adhesive layer 104 may be any adequate adhesive. In one embodiment, the adhesive layer 104 is a pressure-sensitive adhesive comprising at least one of silicone, natural or synthetic rubber, thermal plastic elastomer, polyurethane, water or solvent based acrylic, or the like. In one embodiment, the adhesive layer 104 is a rubber-based pressure-sensitive adhesive. Other embodiments of the present invention utilize a residue-free adhesive layer 104. Exemplary residue-free adhesives include, but are not limited to, acrylic, silicone, polyurethane, rubber, or the like. The adhesive layer 104 may also be an aggressive compounded adhesive, such as, for example, those described in U.S. Pat. Nos. 4,880,880; 4,997,709; and 5,405,703; each of which is incorporated herein by reference in its entirety. The adhesive layer 104 may be applied to a side of the backing layer 102 or film layer 108.

In other embodiments of the present invention, the adhesive layer 104 includes a tackifying resin to improve application of the adhesive tape 100 in cold temperatures. The tackifying resin may be any adequate tackifying resin. In one embodiment, the adhesive layer 104 includes about 5 percent to about 30 percent by weight of the tackifying resin. In another embodiment, the adhesive layer 104 comprises at least one of a terpene phenolic resin, a rosin ester resin, a C₅ or C₉ hydrocarbon resin or blends thereof. In another embodiment, the adhesive layer 104 includes about 5 percent to about 30 percent by weight of a rosin ester resin.

The optional release liner 106 may be applied to an exposed side of the adhesive layer 104. The release liner material 106 may be a silicone liner material, or non-silicone release liner material, such as polyvinyl octadecylcarbamate. Other types of release liners 106 include, but are not limited to polyvinyl stearylcarbamate, vinyl acrylic emulsion release liner material, and a fluorochemical emulsion with an acrylic backbone.

In alternative embodiments, the release liner 106 may be provided as a layer applied on the backing 101. In such an embodiment, when the adhesive tape 100 is provided in a roll, the force required to unroll the adhesive tape 100 is substantially less than it would be on an adhesive tape 100 of the present invention provided without such a release liner. In one embodiment, the release liner 106 may comprise a non-silicone material, for example polyvinyl octadecylcarbamate or polyvinyl stearylcarbamate.

The force at which the adhesive tape 100 breaks when a tensile force is applied is commonly denoted as the tensile strength. In one embodiment, the adhesive tape 100 has a minimum tensile strength of at least about 50 pounds/inch. In another embodiment, the adhesive tape 100 has a tensile strength in a range of about 50-100 pounds/inch. In yet another embodiment, the adhesive tape 100 has a tensile strength of at least one of about 50, 55, 60, 65, 70, 75, or 80 pounds/inch.

Despite high tensile strength, embodiments of the present invention provide adhesive tapes with relatively low tear strength, i.e., the force at which the interlaced threads fail due to a tear force, such that the adhesive tapes are hand-tearable. Generally, a hand-tearable tape is a tape that may be torn by hand without the use of a cutting or tearing tool. In one embodiment, the adhesive tape 100 has a tear strength in a range of about 0.01 pounds to about 10 pounds. In another embodiment, the adhesive tape has a tear strength in a range of about 0.05 pounds to about 5 pounds.

In an alternate embodiment, stabilizers may be added to either the backing layer 101 and/or the adhesive layer 104 to improve the UV resistance and deter thermal degradation. Where multiple film layers 108 exist in the backing layer, a stabilizer may be added to one of the film layers 108. The stabilizers may be applied in at least single or multiple layers.

In one embodiment, the stabilizers include any high molecular weight stabilizer. In another embodiment, the stabilizers comprise at least a hindered amine light stabilizer (HALS). In another embodiment, the stabilizer comprises an ultraviolet light absorbing agent, such as 3,5-di-t-Butyl-4-Hydroxybenzoic Acid, Hexadecyl Ester, and a solvent. In yet another embodiment, the stabilizer comprises an ultraviolet light absorbing agent and free radical scavenger, commercially available under the name CYASORB® UV-2908. Additional embodiments provide the stabilizer comprises a UV light stabilizer, commercially available under the name Tinuvin 765.

Antioxidants may also be added to either the backing layer 101 and/or the adhesive layer 104. The antioxidants may include hindered phenols or multifunctional phenols such as those containing sulfur or phosphorus. The performance of either the UV stabilizers or the antioxidants may be further enhanced by utilizing synergists such as, for example, thiodipropionate esters and phosphites, and/or chelating agents and metal deactivators, for example, ethylenediamine tetraacetic acid, salts thereof, and disalicylalpropylenediimine.

In other embodiments, other agents may be incorporated into the adhesive tape 100. In one embodiment, a fungicide is applied to the adhesive tape to resist fungal growth. Exemplary fungicides include miconazol, amphotericin B, nystatin, griseofulvin, and the like. Embodiments of the present invention may further comprise any bioactive agent or the like, to prevent any undesirable biological growth or presence in the adhesive tape 100.

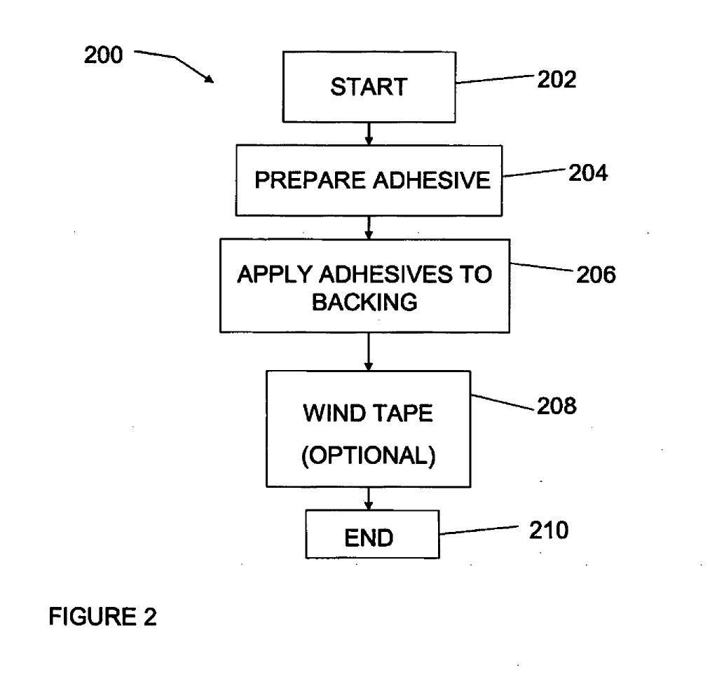

FIG. 2 depicts a flowchart of a method for making an adhesive tape in accordance with one embodiment of the present invention. The method 200 begins at step 202. At step 204, an adhesive is prepared. In one embodiment, the adhesive is compounded in an intensive mixer such as a banbury or extruder. Where a rubber-based adhesive is utilized, the rubber compounds are introduced in pellet, slab, liquid, or solid (e.g., flakes, powders, etc.) form, then heated and mixed until they are melted and substantially homogeneous. Other ingredients are added to the blend tank as specified in the formulation, including any tackifying agents, viscosity modifiers, antioxidants, or the like. The final mixture is thick but smooth enough to be pumped to a holding tank connected to the coating equipment.

At step 206, the adhesive and the backing layer 101 are combined using sophisticated coating equipment. In one embodiment, the adhesive is softened by heat on a roller mill. A roller mill typically consists of closely spaced hollow rollers made of heavy gauge stainless steel. The rollers are attached to high torque gears and a motor, and are rotated at a predetermined speed. The temperature of the rollers is continuously regulated by pumping water through the center of the rollers. In one embodiment, a top roller is held at a temperature between about 230° F. and about 290° F. and a center roller is maintained between about 80° F. and about 120° F. The rollers are generally fixed in a position that allows only a small gap or nip between them. As the rollers rotate, the adhesive is fed into this space, which in turn, heats and softens the adhesive. This arrangement allows the molten adhesive to form a thin sheet across the surface of the rollers.

In one embodiment, the backing layer 101 is fed into a coating machine through a second set of rollers. A third roller, maintained between about 180° F. and about 230° F., places the backing layer 101 in contact with the adhesive. At this stage in the process, generally known as coating, the adhesive is transferred to the backing layer 101, forming an adhesive layer 104. By controlling the gaps between the rollers, the thickness of the adhesive layer 104 can be regulated. Adhesive layers as thin as about 0.002 inch can be created, but it become difficult to retain uniformity below about 0.004 inch.

At step 208, the backing layer 101 and adhesive layer 104, collectively forming an adhesive tape 100, may optionally be wound onto large cores. When a sufficient length of adhesive tape 100 is on a core, it is removed and cut to the proper size. The method 200 ends at step 210, resulting in an adhesive tape 100 as described in connection with FIG. 1 above.

While the foregoing is directed to embodiments of the present invention, other and further embodiments of the invention may be devised without departing from the basic scope thereof.

1.-20. (canceled)

21. A high tensile strength adhesive tape comprising:
a woven cloth scrim having a first side and a second side,
a film adhered to the first side of the scrim layer, and
an adhesive layer affixed to the second side of the scrim layer,
wherein the scrim has a plurality of interlaced threads arranged in a grid density of between about 5×10 threads per square inch to about 50×100 threads per square inch, the adhesive tape has a tensile strength of at least 50 pounds per inch, and a tear strength of less than about 10 pounds, and the adhesive layer has adhesion for the film in the range of about 50 ounce-force/inch to about 200 ounce-force/inch.

22. The high tensile strength adhesive tape as claimed in claim 21, wherein the adhesive layer is a pressure-sensitive adhesive layer.

23. The high tensile strength adhesive tape as claimed in claim 22, wherein the pressure-sensitive adhesive layer has silicone, natural or synthetic rubber, thermal plastic elastomer, or polyurethane.

24. The high tensile strength adhesive tape as claimed in claim 21, wherein the grid density is about 28×44 threads per square inch.

25. A high tensile strength adhesive tape comprising:
a scrim layer having a first side and a second side,
a film adhered to the first side of the scrim layer, and
an adhesive layer adhered to the second side of the scrim layer,
wherein the adhesive tape has a tensile strength of at least about 50 pounds per inch, and a tear strength of less than about 10 pounds.

26. The high tensile strength adhesive tape as claimed in claim 25, further comprising a release liner affixed to the adhesive layer.

27. The high tensile strength adhesive tape as claimed in claim 25, wherein the adhesive layer is a pressure-sensitive adhesive layer.

28. The high tensile strength adhesive tape as claimed in claim 25, wherein the adhesive layer has adhesion for the film of about 50 ounce-force/inch to about 200 ounce-force/inch.

29. The high tensile strength adhesive tape as claimed in claim 25, wherein the adhesive layer has adhesion for the film of about 50 ounce-force/inch to about 150 ounce-force/inch.

30. The high tensile strength adhesive tape as claimed in claim 25, wherein the adhesive layer has adhesion for the film of about 75 ounce-force/inch to about 125 ounce-force/inch.

31. The high tensile strength adhesive tape as claimed in claim 25, wherein the film layer is a polyethylene film.

32. The high tensile strength adhesive tape as claimed in claim 25, wherein the adhesive layer comprises a tackifying resin, and the tackifying resin is about 5% by weight to about 30% by weight of the adhesive layer.

33. The high tensile strength adhesive tape as claimed in claim 25, wherein the scrim is a woven cloth material having a plurality of interlaced threads arranged in a grid density of between about 5×10 threads per square inch to about 50×100 threads per square inch.

34. The high tensile strength adhesive tape as claimed in claim 25, wherein the grid density is about 28×44 threads per square inch.

35. The high tensile strength adhesive tape as claimed in claim 25, wherein the adhesive tape has a tensile strength between about 50 pounds per inch and about 100 pounds per inch.

36. The high tensile strength adhesive tape of claim 25, wherein the grid density is about 28×44 threads per square inch.

37. A method for preparing a high tensile strength adhesive tape, comprising the steps of:
providing an adhesive that is able to be pumped into a holding tank,
providing a backing material having a scrim having a plurality of interlaced threads arranged in a grid density of between about 5×10 threads per square inch to about 50×100 threads per square inch, and
coating the adhesive onto the backing material to form an adhesive layer having adhesion for the scrim in the range of about 50 ounce-force/inch to about 200 ounce-force/inch.

38. The method as claimed in claim 37, wherein the adhesive is coated onto the backing material using a set of rollers maintained at a temperature above 180° F.

39. The method as claimed in claim 37, wherein the adhesive is a pressure-sensitive adhesive.

40. The method as claimed in claim 37, further comprising the step of winding the backing material and the adhesive layer about a core.
